(19) United States
(12) Patent Application Publication
(10) Pub. No.: US 2025/0312799 A1
(43) Pub. Date: Oct. 9, 2025

(54) MATERIAL PROCESSING APPARATUS AND METHOD

(71) Applicants: Lee Alan Schunk, Clare, MI (US); Michael J. Schunk, Clare, MI (US)

(72) Inventors: Lee Alan Schunk, Clare, MI (US); Michael J. Schunk, Clare, MI (US)

(21) Appl. No.: 19/087,142

(22) Filed: Mar. 21, 2025

Related U.S. Application Data
(60) Provisional application No. 63/568,161, filed on Mar. 21, 2024.
(60) Provisional application No. 63/745,985, filed on Jan. 16, 2025.

(51) Int. Cl. B02C 13/288

(52) U.S. Cl. CPC B02C 13/288

(57) ABSTRACT

An apparatus for comminuting material includes features that enable a user to alter or adjust operating parameters to optimally comminute a wide variety of materials. The apparatus includes wedges and vane tips that are removable and interchangeable with other wedges and vane tips to alter the zones of varying pressure, pressure differentials, shock waves, expansion fans, or other types of interference waves formed during operation. Temperature control systems and heat exchangers are used to independently control temperatures at different regions of the apparatus so that a user can control processing temperatures, which may vary depending on the material being processed. Corresponding methods of use are also provided.

### CROSS-REFERENCE TO RELATED APPLICATIONS

This application claims the benefit of U.S. Provisional Patent Application No. 63/568,161, filed Mar. 21, 2024, and U.S. Provisional Patent Application No. 63/745,985, filed Jan. 16, 2025, both of which are hereby incorporated by reference in their entireties.

### TECHNICAL FIELD

This disclosure relates to apparatuses and methods for comminuting materials.

### BACKGROUND

Pulverizing or crushing solid materials into smaller units is important in many industries, including but not limited to material recycling, agricultural product processing, mining, etc. The prior art includes techniques such as mechanical grinding, crushing, etc.

More recently, the prior art has included devices, sometimes referred to as “wave mills,” that create zones of rapidly changing fluid velocity and pressure that result in shockwaves or other waves that break apart material being processed into smaller particle sizes. Wave mills are more efficient than mechanical grinders, crushers, etc. However, prior art wave mills have had limited utility, especially for agricultural product processing and recycling.

### SUMMARY

An apparatus for processing materials using zones of varying pressure, pressure differentials, shock waves, expansion fans, or other types of interference waves is provided. The apparatus improves on the prior art by providing a high degree of control of conditions throughout the machine to enable successful processing of a wider variety of materials than is achievable with prior art wave mills. A corresponding method of using the apparatus is also provided.

The above features and advantages and other features and advantages of the present disclosure are readily apparent from the following detailed description of the best modes for carrying out the disclosure when taken in connection with the accompanying drawings

### BRIEF DESCRIPTION OF THE DRAWINGS

FIG. 1 is a schematic, cross-sectional side view of a material processing apparatus;

FIG. 2 is a schematic, sectional front view of the apparatus;

FIG. 3 is a schematic, front view of the apparatus with housing assemblies in their respective closed positions;

FIG. 4 is a schematic, front view of the apparatus with the housing assemblies in their respective open positions;

FIG. 5 is a schematic, perspective view of an end of a vane with a first vane tip mounted thereto;

FIG. 6 is a schematic, perspective view of the end of the vane with a second vane tip mounted thereto;

FIG. 7 is a schematic, perspective view of the end of the vane with a third vane tip mounted thereto;

FIG. 8 is a schematic, perspective view of the end of the vane with a fourth vane tip mounted thereto;

FIG. 9 is a schematic, perspective view of a first wedge member;

FIG. 10 is a schematic, perspective view of a second wedge member;

FIG. 11 is a schematic, perspective view of a third wedge member;

FIG. 12 is a schematic, perspective view of a fourth wedge member;

FIG. 13 is a schematic, perspective view of a fifth wedge member;

FIG. 14 is a schematic, perspective view of a sixth wedge member;

FIG. 15 schematically depicts various positions of an insert defining an outlet for the apparatus;

FIG. 16 is a schematic depiction of the apparatus with accessories attached at the inlet or the outlet;

FIG. 17 is a schematic depiction of a rotor plate having an alternative vane configuration;

FIG. 18 is a schematic depiction of a method of replacing vane tips and wedge members to vary the effective diameter of a chamber;

FIG. 19 is a schematic, cross-sectional side view of an alternative material processing apparatus; and

FIG. 20 is another schematic, cross-sectional side view of the alternative material processing apparatus.

### DESCRIPTION OF THE PREFERRED EMBODIMENTS

Referring to the Figures, wherein like reference numbers refer to like components throughout, an apparatus 10 for processing material is schematically depicted. The apparatus 10 is a pressure interference wave mill that improves upon the prior art by enabling a user to adjust various operating parameters to enable the milling of a wide variety of materials. In the embodiment depicted, the apparatus 10 includes a first housing 14 defining a first cylindrical chamber 18 and a second housing 22 defining a second cylindrical chamber 26. More specifically, the first housing 14 includes two annular bases 30, 34 that are parallel to one another. The first housing 14 also defines a cylindrical inner surface 38 that cooperates with the bases 30, 34 to define the chamber 18.

The first housing 14 includes three arcuate bands 42A, 42B, 42C. The cross-sectional shape of each arcuate band 42A, 42B, 42C is an arc forming one third of the circumference of a circle. Each band 42A, 42B, 42C has a respective concave curved surface 46A, 46B, 46C. The bands 42A, 42B 42C are connected to one another such that each of the surfaces 46A, 46B, 46C forms one third of the cylindrical inner surface 38. The bands 42A, 42B, 42C are also connected to the bases 30, 34 to form a cylinder.

Similarly, the second housing 22 includes two annular bases 50, 54 that are parallel to one another. The second housing 22 also defines a cylindrical inner surface 58 that cooperates with the bases 50, 54 to define the chamber 26.

The second housing 14 includes three arcuate bands 62A, 62B, 62C. Each arcuate band 62A, 62B, 62C is an arc forming one third of the circumference of a circle. Each band 62A, 62B, 62C has a respective concave curved surface 66A, 66B, 66C. The bands 62A, 62B 62C are connected to one another such that each of the surfaces 66A, 66B, 66C forms one third of the cylindrical inner surface 58. The bands 62A, 62B, 62C are also connected to the bases 50, 54 to form a cylinder.

A first conduit 70 defines a first passageway 76 into the first chamber 18 that extends through base 30. A second conduit 80 defines a second passageway 84 that extends out of the second chamber 26 through base 54. The first passageway 76 provides an inlet into the first chamber 18 for unprocessed material 88 to be drawn into the chamber 18 for processing, and the second passageway 84 is an outlet from the chamber 26 for processed material 92.

A shaft 96 is rotatably mounted with respect to the housings 14, 22 and extends through the chambers 18, 26 along the axis of each chamber 18, 26. A motor 100 is operatively connected to the shaft 96 and configured to selectively cause the shaft 96 to rotate relative to the housings 14, 22.

The apparatus 10 further includes a first rotor plate 104 located within the first chamber 18 and mounted with respect to the shaft 96 for rotation therewith. A second rotor plate 106 is located within the second chamber 26 and mounted with respect to the shaft 96 for rotation therewith. Each rotor plate 104, 106 has vanes 108 as shown. It should be noted that a rotor plate may also be sometimes referred to as a “turbine plate.”

It should be noted that housing 22 is substantially similar to housing 14 except that housing 22 has a significantly larger diameter than housing 14 and, correspondingly, chamber 26 has a significantly larger diameter than chamber 18. Likewise, rotor plate 106 is substantially similar to rotor plate 104 except that rotor plate 106 has a significantly larger diameter than rotor plate 104.

Each of the annular bases 30, 34, 50, 54 defines a respective central aperture 110, 114, 118, 122. The shaft 96 extends through each of the apertures 110, 114, 118, 122. The apparatus 10 in the embodiment depicted further includes a first heat exchanger unit 126 mounted to base 30 and a second heat exchanger unit 130 mounted to base 54. Each of the heat exchanger units 126, 130 defines a respective annular passageway 134, 138 through which heated or cooled air or other heated or cooled fluids flow to transfer heat to or from the first and second chambers 18, 26.

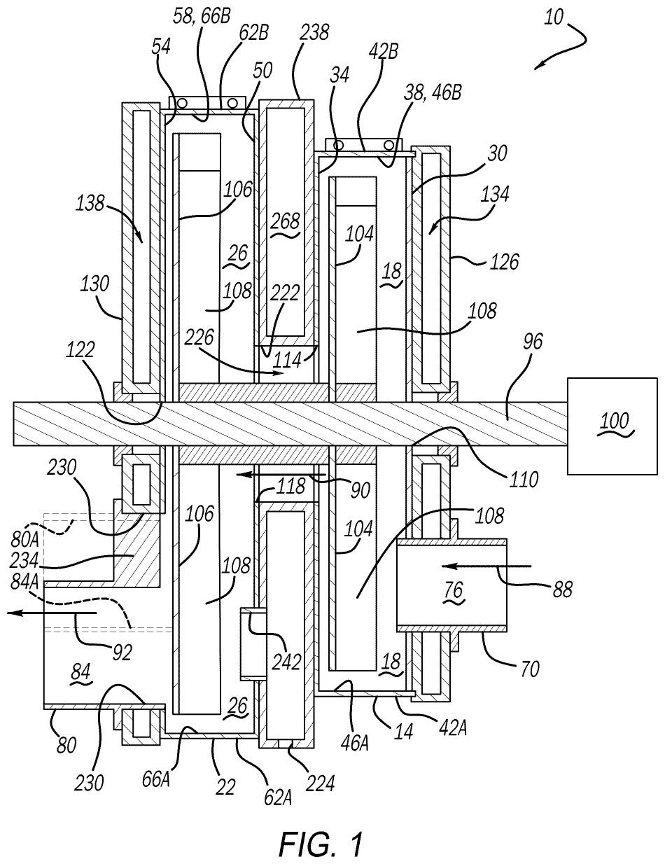

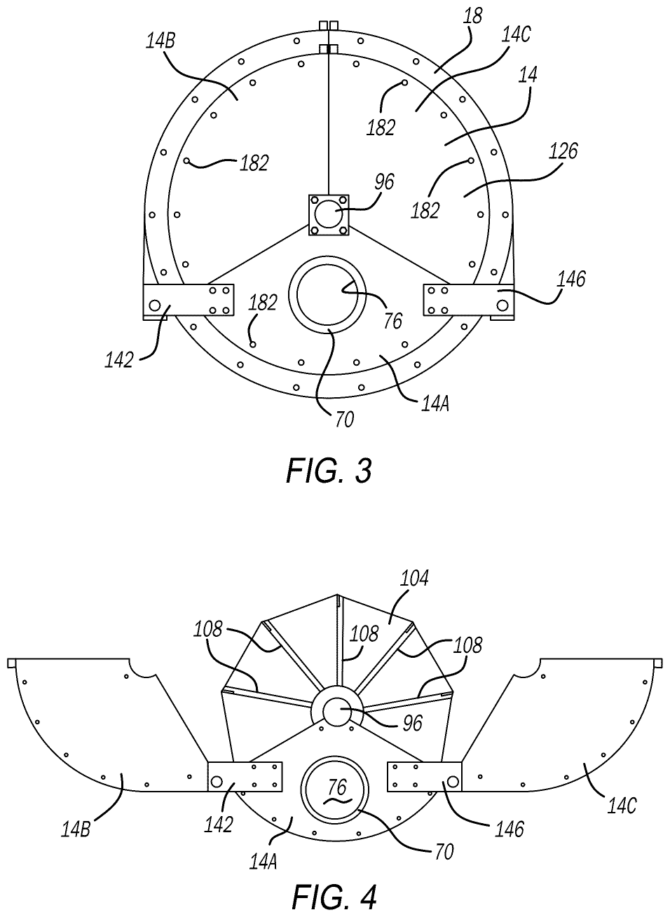

The first housing 14 has first, second, and third housing assemblies 14A, 14B, 14C. The first housing assembly 14A defines a first sector of the first cylindrical chamber 18. The second housing assembly 14B defines a second sector of the first cylindrical chamber 18. The third housing assembly 14C defines a third sector of the first cylindrical chamber 18. The second housing 14B assembly is pivotably connected to the first housing assembly 14A via hinge assembly 142 and pivotable between an open position (as shown in FIG. 4) and a closed position as shown in FIGS. 1-3.

Similarly, the third housing assembly 14C is pivotably connected to the first housing assembly 14A via a hinge assembly 146 and pivotable between an open position (as shown in FIG. 4) and a closed position as shown in FIGS. 1-3. The first, second, and third housing assemblies 14A, 14B, 14C cooperate to define the first cylindrical chamber 18 when the second and third housing assemblies 14B, 14C are in their respective closed positions.

Each of the first, second, and third housing assemblies 14A, 14B, 14C includes a respective arcuate band 42A, 42B, 42C, each of said arcuate bands cooperating to define the cylindrical surface of the first cylindrical chamber 18 when the second and third housing assemblies 42B, 42C are in their respective closed positions. Likewise, each of the bases 30, 34 is comprised of three annular sectors that are part of a respective one of the housing assemblies 14A, 14B, 14C and that are movable relative to one another.

When the first, second, and third housing assemblies 14A, 14B, 14C are in their closed positions, the rotor plate 104 is enclosed for material processing. When the first, second, and third housing assemblies 14A, 14B, 14C are in their open positions, the rotor plate 104 is at least partially exposed for cleaning, maintenance, etc. In the embodiment depicted, the housing assemblies are connected to each other via flanges.

More specifically, each of the bands 42A, 42B, 42C has a flange on each end, as shown in the Figures. Each flange defines one or more holes. Each flange contacts another flange on another of the bands 42A, 42B, 42C and fasteners are driven through the holes of both bands. However, those skilled in the art will recognize other devices and techniques that may be employed within the scope of the claimed invention for locking the housing assemblies 14A, 14B, 14C in their closed positions.

The second housing 22 has substantially similar construction as the first housing 14 but is configured such that the second cylindrical chamber 26 has a significantly larger diameter than the first cylindrical chamber 14.

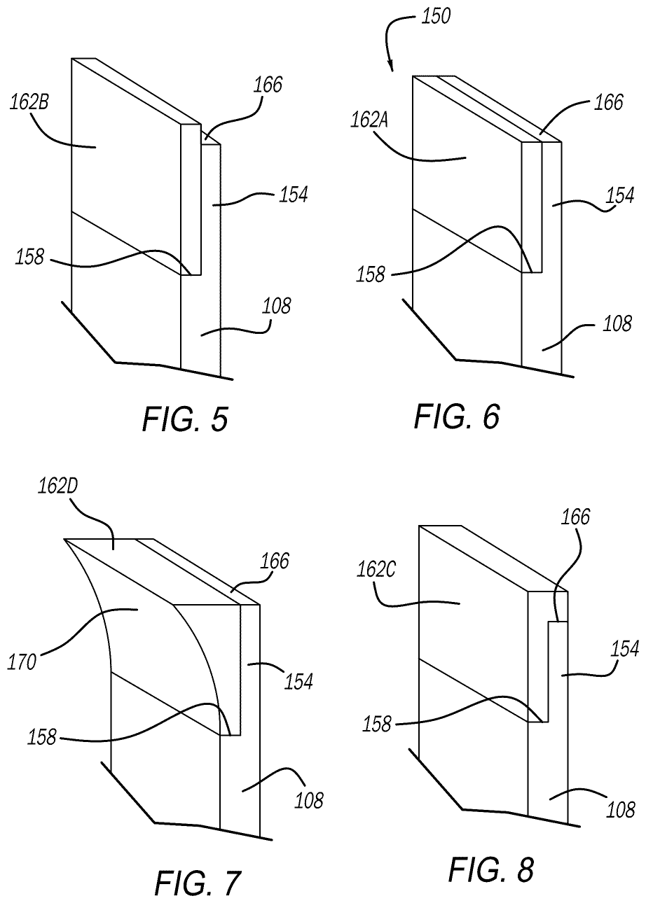

A shaft 96 extends through the first and second chambers 18, 26. A first rotor plate 104 having a plurality of vanes 108 protruding from one side of the plate 104 is mounted to the shaft 96 for rotation therewith in the first cylindrical chamber 18. A second rotor plate 106 having a plurality of vanes 108 protruding from one side of the plate 106 is mounted to the shaft 96 for rotation therewith in the second cylindrical chamber 26. Each of the vanes 108 extends radially with respect to the shaft 96 and has an interface 150 at which any one of a plurality of tips having various sizes and configurations (shown at 162A-162D in FIGS. 5-8) is mountable to vary the effective length of the vane 108 and the geometry of the vane 108.

More specifically, each vane 108 has a segment 154 of reduced thickness at the distal end of the vane 108 such that the transition from higher thickness to reduced thickness results in a lip 158. Each of the tips 162A-162D is matable with one of the vanes 108 such that the tip 162A-162D contacts the segment 154 and abuts the lip 158. Fasteners (not shown) retain the tip 162A-162D with respect to the vane 108. As shown in FIG. 6, a tip 162A may be attached to the vane 108 such that the tip 162 abuts the lip 158 but does not protrude radially past the end 166 of the vane 108. To extend the effective length of the vane 108, tip 162A may be removed and either tip 162B (as shown in FIG. 5) or tip 162C (as shown in FIG. 8) may be attached to the vane 108 such that the tips 162B, 162C abut the lip 158 and extend past the end 166. Alternatively, tip 162D, as shown in FIG. 7, may be attached to increase the effective terminal width of the vane 108 and provide a curvilinear surface 170.

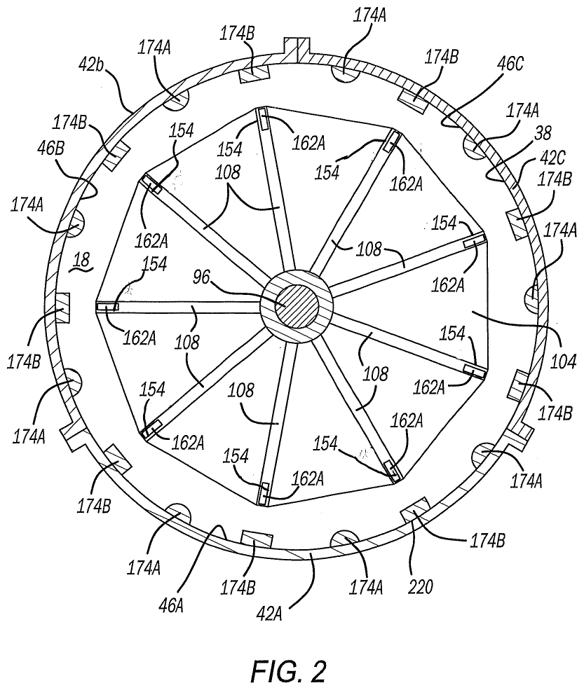

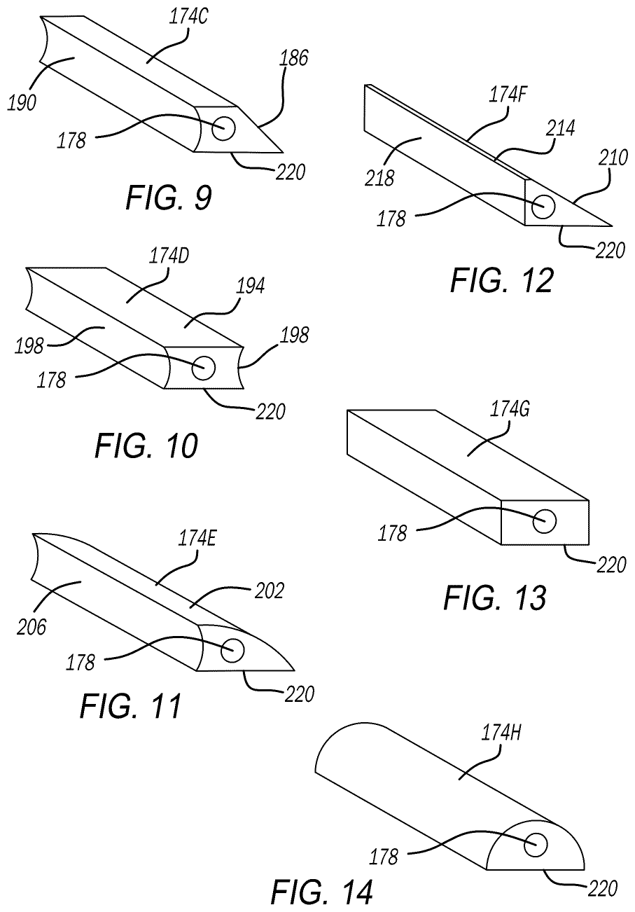

Referring specifically to FIG. 2, the apparatus 10 includes a plurality of wedge members 174A, 174B that are operatively connected to the first housing 14 such that the wedge members 174A, 174B are within the first chamber 18 and radially outward from the vanes 108. As shown in FIG. 2, each wedge member abuts the inner surface 38 defined by arcuate members 42A, 42B, 42C. Each wedge member (as shown in FIGS. 9-14) defines a hole 178 therethrough. Wedge members 174A, 174B are mounted within the chamber 14 by passing fasteners through the holes 178 and through holes 182 in the bases 30, 34 of the housing 14. Wedge members are mounted within the second chamber 26 in the same manner.

Thus, the wedge members 174A, 174B are selectively attachable and removable from the first and second chambers. Accordingly, for example, and with continued reference to FIG. 2, a user could remove all of wedge members 174B from the chamber 18 and operate the apparatus only with the wedge members 174A remaining. Likewise, a user could replace wedge members 174A or 174B with other wedge members having a different size of shape than wedge members 174A, 174B. FIGS. 9-14 depict other wedge member configurations that are interchangeable with wedge members 174A, 174B depending on the requirements of the material being processed by the apparatus 10. FIG. 9 depicts a wedge member 174C with a sharp ramp 186 and a radius release 190 for low air pressure. FIG. 10 depicts a wedge member 174D having a flat, planar top 194 with curvilinear surfaces 198 on both sides for more air change pressure. FIG. 11 depicts a wedge member 174E having a rounded slope 202 with a concave release surface 206 for more compression. FIG. 12 depicts a wedge member 174F having a longer ramp 210 with very little top 214 and a planar release surface 218 for a higher speed volume increase. FIG. 13 depicts a wedge member 174G that is a rectangular prism for processing material that is high density and needs an impact point. FIG. 14 depicts a wedge member 174H that is a semi-cylinder for low resistance and material will flow with high volume. All wedge members include a surface 220 that abuts surface 38 when installed.

Thus, the apparatus 10 is configured such that wedges of varying sizes and shapes are selectively attachable to achieve different zones of varying pressure, pressure differentials, shock waves, expansion fans, or other types of interference waves formed by the rotation of the vane tips 162A-162D past the wedge members 174A-174H during rotation of the rotor plates. Wedge members are likewise installed in the second chamber 26.

Conduit 70 extends through the first housing 14 and defines a first passageway 76 into the first chamber 18. The second conduit 80 defines a second passageway 84 that is an outlet from the second chamber 26. A third conduit 222 is coaxially disposed with the shaft 96 and defines a third passageway 226 from the first chamber 18 to the second chamber 26. Accordingly, during use of the apparatus 10, unprocessed material 88 enters the first chamber 18 via the first passageway 76; the material 88 is broken into smaller pieces within the first chamber 18 by the action of the rotating rotor plate 104. Accordingly, after being processed in the first chamber 18, the material 88 becomes partially processed material 90, which travels through the third passageway 226 to the second chamber 26.

The material 90 is further processed in the second chamber 26 by the action of the rotating second rotor plate 106 whereby material 90 is transformed into processed material 92. Processed material 92 leaves the second chamber 26 through the passageway 84 formed by the second conduit 80.

The third conduit 80 is selectively movable relative to the second housing 22 such that the third passageway 84 is selectively movable radially with respect to the shaft 96.

More specifically, the housing 22 defines a circular aperture 230 that extends through the second heat exchanger 130 and the base 54. An insert 234 is insertable into the aperture 230. The insert 234 defines conduit 80. The diameter of the passageway 84 is less than the diameter of aperture 230. Furthermore, the conduit 80 and passageway 84 are eccentric relative to the centerline of the aperture 230. Accordingly, if the insert 234 is rotated within the aperture 230, the conduit 80 and the passageway 84 move radially relative to the shaft 96. For example, by rotating the insert 234 one hundred and eighty degrees about an axis parallel to the shaft 96, the conduit and passageway are movable from the positions shown at 80 and 84 in FIG. 1 to the positions shown in phantom at 80A and 84A.

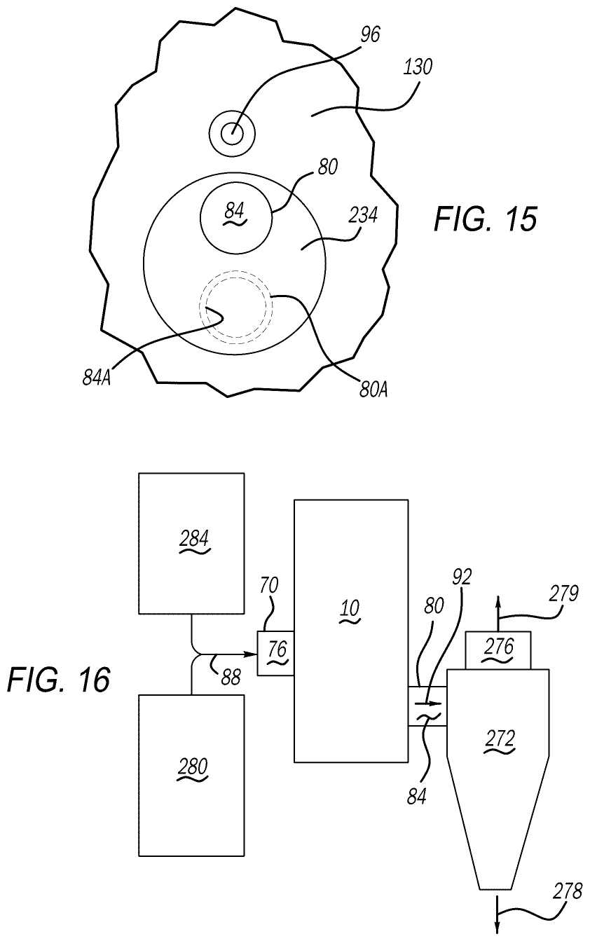

FIG. 15 also depicts rotation of the insert 234 to change the distance between the shaft 96 and the outlet passageway 84. Referring to FIG. 15, the conduit 80 and the outlet passageway 84 are depicted proximate to the shaft 96. The distance between the shaft 96 and the conduit 80 (and, corresponding, the passageway 84) is increased by rotating the insert 234. Rotating the insert one hundred and eighty degrees will move the conduit and the passageway to the positions shown in phantom at 80A and 84A, thereby maximizing the distance between the shaft 96 and the outlet passageway 84.

The insert 234 is selectively removable from the aperture 230, and an insert having a conduit defining a passageway larger or smaller than the passageway 84 can then be inserted into the aperture 230 so that the size of the outlet is selectively variable.

The first housing 14 defines a first heat exchanger 126 that defines a first heat exchange fluid passageway 134 in conductive heat transfer relationship with the first chamber 18 via the base 30. The second housing 22 defines a second heat exchanger 130 that defines a second heat exchange fluid passageway 138 in conductive heat transfer relationship with the second chamber 26 via the base 54. Accordingly, the temperature of the first and second chambers 18, 26 is controllable by causing the flow of a fluid through the first and/or second fluid passageways 134, 138. Alternatively, heat sources such as electrical resistance heating elements may be placed in heat transfer relationship with the chambers 18, 26.

Structure 238 defines an annular enclosed space 268 positioned between the first and second housings 14, 18. A fourth conduit 242 extends from the space 268 through the base 50 and into the second chamber 26, thereby providing fluid communication between the space 268 and the second chamber 26. Structure 238 defines an inlet port 224 into the space 268. Fluid is injectable into the second chamber 26 to bypass the first chamber 18. First and second heat exchangers also include respective inlet and outlet ports (not shown) for the flow of heat exchange fluid.

Referring to FIGS. 1 and 16, a cyclone 272 and a vacuum or suction generator 276 are positioned at or adjacent to the outlet, i.e., conduit 80 to separate dry material 278 and moist air 279, i.e., the cyclone 272 and the vacuum or suction generator 276 receive the processed material 92 from the conduit 80 and remove moist air therefrom, leaving dried material 278. The cyclone and vacuum should be placed as close as possible to the outlet conduit 80 for optimal operation. A heater 280 is positioned to heat material prior to entry into the first chamber 18 through the first conduit 70. A source 284 of warm dry air is positioned to selectively inject warm, dry air into the first conduit 70 with the heated material.

In operation, the shaft 96 rotates, thereby causing the first and second rotor plates 104, 106 to rotate such that zones of varying pressure, pressure differentials, shock waves, expansion fans, or other types of interference waves are formed by the rotation of the vane tips past the wedge members. A user may heat or cool the first chamber by causing fluid to flow through the first heat exchange fluid passageway. The user may heat or cool the second chamber by causing fluid to flow through the second heat exchange fluid passageway. The user may inject gas without oxygen (e.g., nitrogen) into either the first conduit 70 or the fourth conduit 242.

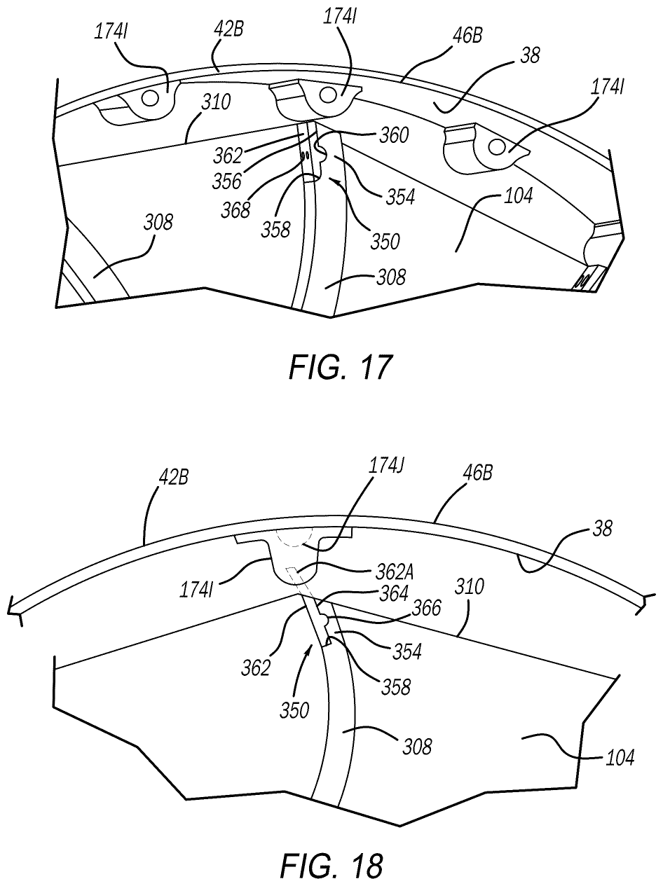

FIGS. 17 and 18 schematically depict an alternative vane construction that may be employed within the scope of the claimed invention. FIGS. 17 and 18 depict vanes 308 on plate 104, though either or both plates 104, 106 may include vanes 308 within the scope of the claimed invention. Vanes 308 are similar to vanes 108, except that vanes 308 are curved as they extend between the shaft 96 and the periphery 310 of the plate 104. Furthermore, the interface 350 at which tips are mountable to the vanes 108 differs from the interfaces shown at 150. Each vane 308 has a segment 354 of reduced thickness and a lip 358 at the transition to increased thickness. Segment 354 has a substantially planar surface 356 that is interrupted by a semi-cylindrical concavity 360 that forms a geometrical interlocking feature for tips, such as the one shown at 362.

More specifically, tip 362 includes a surface 364 having a semi-cylindrical protuberance 366 that is positioned such that the protuberance 366 is within the concavity 360 when the tip 362 is mounted to the vane 308. The tip 362 defines a plurality of holes 368 extending therethrough. The tip 362 is mounted to the vane 308 by engaging fasteners (not shown) through the holes 368 and holes in the vane 308.

FIG. 18 schematically depicts a method of varying the effective diameter of a chamber 18 by installing different tips and wedges. Tip 362 does not extend past the periphery 310 of the plate 104. Wedge member 174I is positioned such that it extends radially inward from the surface 38, and there is a clearance between the wedge member 174I and the tip 362 as the tip 362 moves past the wedge member 174I during rotation of the plate 104. Each of the vanes 308 on the plate 104 has a tip 362 mounted thereto, and a plurality of wedge members 174I are mounted within the chamber 18.

The effective diameter of the chamber 18 can be increased by removing tips 362 from each of the vanes 308 and replacing them with longer tips (shown in phantom at 362A). Tips 362A extend beyond the periphery 310, and would collide with wedge members 174I during rotation of the plate 104. Accordingly, a user would remove wedge members 174I from the chamber 18, and replace them with wedge members (shown in phantom at 174J) having a smaller radial dimension than wedge members 174I, thereby providing clearance between the tips 362A and the wedge members 174J during operation of the apparatus 10, and providing a larger effective diameter of chamber 18. The tips and wedges in chamber 26 may likewise be varied to alter the effective diameter of chamber 26.

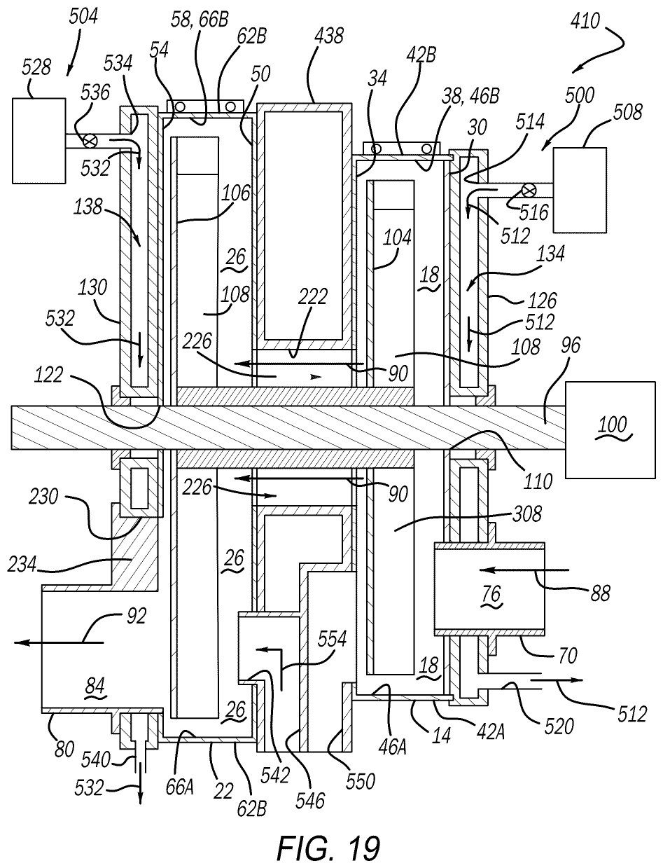

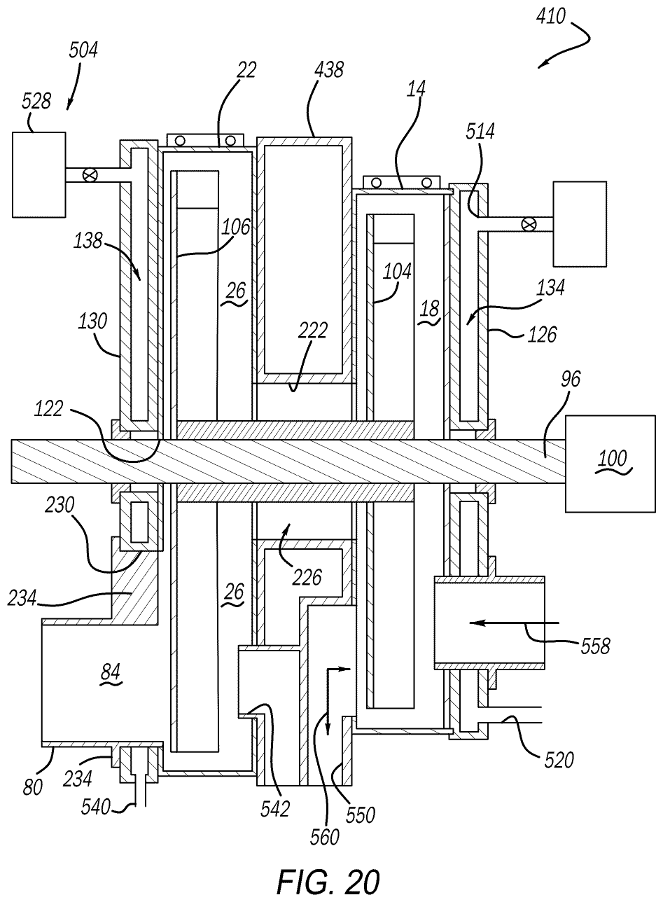

Referring to FIGS. 19 and 20, an alternative apparatus 410 is schematically depicted. Apparatus 410 is substantially identical to the apparatus 10 except that structure 238 is replaced with structure 438, and temperature control systems 500, 504 are shown connected to heat exchangers 126, 130, respectively. Structure 438 defines a conduit 542 that functions in the same manner as conduit 242 to provide a direct passageway 546 from the exterior of the apparatus 410 into the second chamber 26. Structure 438 also defines an outlet 550 from the first chamber 18 to the exterior of the apparatus 410, and may be employed by a user to extract material after it has been processed within the first chamber 18 to avoid further processing of the material in the second chamber 26.

Temperature control system 500 includes a source 508 of pressurized fluid 512. The source 508 is in fluid communication with the passageway 134 of the first heat exchanger 126 through an inlet port 514. The flow of fluid 512 into the passageway 134 is controllable by a user. For example, a valve 516 may control the flow rate of fluid 512 into the chamber 134. Similarly, the source 508 may include a pump or compressor that is controllable to vary the flow rate of the fluid 512. The source 508 may also include a device for controlling the temperature of the fluid 512, such as a heater or refrigeration system. Accordingly, a user may control the temperature and flow rate of fluid 512 through the heat exchanger 126 and thereby control the temperature of the first chamber 18 and any material being processed therein. Fluid 512 is discharged from the passageway 134 via an outlet 520 in the heat exchanger 126.

Similarly, temperature control system 504 includes a source 528 of pressurized fluid 532. The source 508 is in fluid communication with the passageway 138 of the second heat exchanger 130 through an inlet port 534. The flow of fluid 532 into the passageway 138 is controllable by a user. For example, a valve 536 may control the flow rate of fluid 532 into the chamber 138. Similarly, the source 528 may include a pump or compressor that is controllable to vary the flow rate of the fluid 532. The source 528 may also include a device for controlling the temperature of the fluid 532, such as a heater or refrigeration system. Accordingly, a user may control the temperature and flow rate of fluid 532 through the heat exchanger 130 and thereby control the temperature of the second chamber 26 and any material being processed therein. Fluid 532 is discharged from the passageway 138 via an outlet 540 in the heat exchanger 130.

Using the apparatus 410 may include activating the motor 100 to cause the rotor 96 to rotate, which in turn causes the plates 104, 106 to rotate. The rotation of the plates 104, 106 causes the tips mounted to the vanes 308 to pass the wedge members, resulting in zones of varying pressure, pressure differentials, shock waves, expansion fans, or other types of interference waves that act to pulverize any material passing through the chambers 18, 26.

While the motor 100 is activated and rotating the rotor 96, the method includes injecting unprocessed material 88 into the first chamber 18 through the passageway 76 defined by conduit 70. The unprocessed material 88 becomes partially processed material 90 in the first chamber 18 and flows from the first chamber 18 to the second chamber 26 through the passageway 226. The partially processed material 90 is further processed within the second chamber 26 and exits the second chamber 26 through the passageway 84 as processed material 92.

The conditions required within each chamber 18, 26 for optimal processing will vary greatly depending on the nature of the material being processed. Successful processing of certain materials requires certain pressure differentials, shock waves, expansion fans, or other types of interference waves, which can be altered by changing which tips 162A-D, 362, 362A are installed in the apparatuses 10, 410, and changing which wedge members 174A-J are installed in the apparatuses 10, 410. Accordingly, the method may include selecting wedge members and vane tips from an inventory of wedge members 174A-J and an inventory of vane tips 162A-D, 362, 362A and installing the selected wedge members 174A-J as shown in FIGS. 2 and 17-18.

Successful processing of certain materials may also require a certain temperature range in the first chamber 18 and a different temperature range in the second chamber 26, which can be accomplished by independently controlling the temperature and flow rate of fluids 512, 532 through chambers 134, 138 using temperature control systems 500, 504. Successful processing of certain materials may also require that the outlet passageway 84 be positioned closer to or further from the centerline of the apparatus 10, 410 (i.e., at the rotor 96), which can be accomplished by rotating the insert 234 within the aperture 230.

Furthermore, successful processing of certain materials may require injection of material 554 into the second chamber 26 via passageway 546. Material 554 may include, but is not limited to, inert gas, gas that is resistant to oxidation or displaces oxygen, such as nitrogen, various chemicals or elements that assist in separating materials such as magnesium powder, etc.

Accordingly, using the apparatus 410 may also include causing fluid 512 to flow through passageway 130 at a first temperature and a first flow rate, and causing fluid 532 to flow through passageway 138 at a second temperature and a second flow rate while material 88, 90, 92 is being processed within chambers 18, 26. The first temperature is different from the second temperature and the first flow rate is different from the second flow rate. Using the apparatus may also include injecting material 554 into the second chamber 26 through passageway 546 while material 90 is being processed in the second chamber 26.

Using the apparatus 410 may also include rotating the insert 234 within the aperture 230 to change the distance between the rotor 96 and the outlet passageway 84. For example, in FIG. 21, the insert 234 is positioned such that the conduit 80 and passageway 84 are at a maximum distance from the rotor 96. The method may include rotating the insert 234 from the position shown in FIG. 21 to the position shown in FIG. 22. Referring to FIG. 22, the insert 234 has been rotated one hundred and eighty degrees from its position in FIG. 21, and the conduit 80 and passageway 84 are now at a minimum distance from the rotor 96.

As shown in FIG. 22, some materials 558 may be fully processed within the first chamber 18. Accordingly, the method may also include removing material 560 from the first chamber 18 via passageway 550. It should be noted that some or all of the components that comprise the apparatus 410 may include a non-stick coating, such as but not limited to, polytetrafluoroethylene, silica, anodized aluminum, etc.

While the best modes for carrying out the invention have been described in detail, those familiar with the art to which this invention relates will recognize various alternative designs and embodiments for practicing the invention within the scope of the appended claims.

1. An apparatus comprising:
a first housing defining a cylindrical first chamber;
a second housing defining a cylindrical second chamber;
a shaft that extends through the first and second chambers; and
a first rotor plate within the first chamber, said first rotor plate having a plurality of vanes and being mounted to the shaft for rotation therewith;
a second rotor plate within the second chamber, said second rotor plate having a plurality of vanes and being mounted to the shaft for rotation therewith;
a plurality of wedge members operatively connected to the first housing or the second housing such that the wedge members are within the first chamber or the second chamber and radially outward from the vanes;
wherein each of said vanes extends radially from the shaft and has an interface at which any one of a plurality of tip sizes and configurations is mountable to vary the effective length or geometry of the vane; and
wherein said wedge members are selectively removable such that the number of wedges is selectively variable.

2. The apparatus of claim 1, wherein the apparatus is configured such that the wedge members are selectively removable and interchangeable with other wedge members having different sizes or shapes.

3. The apparatus of claim 1, further comprising a first conduit that extends through the first housing and defines a first passageway into the first chamber;
a second conduit coaxially disposed with the shaft and defining a second passageway from the first chamber to the second chamber; and
a third conduit defining a third passageway that is an outlet from the second chamber;
wherein third conduit is selectively movable relative to the second housing such that the third passageway is selectively movable relative to the shaft.

4. The apparatus of claim 3, wherein the apparatus defines a circular aperture;
wherein the apparatus defines an insert that is rotatably positioned within the aperture; and
wherein the insert defines the third conduit and the third passageway.

5. The apparatus of claim 1, further comprising a first heat exchanger that defines a first heat exchange fluid passageway in conductive heat transfer relationship with the first chamber; and
a second heat exchanger that defines a second heat exchange fluid passageway in conductive heat transfer relationship with the second chamber.

6. The apparatus of claim 5, further comprising a first temperature control system having a first source of pressurized fluid in fluid communication with the first heat exchange fluid passageway;
a second temperature control system having a second source of pressurized fluid in fluid communication with the second heat exchange fluid passageway; and
wherein the first and second temperature control systems are independently controllable.

7. The apparatus of claim 3, further comprising a fourth conduit that defines an inlet into the second chamber.

8. The apparatus of claim 3, further comprising a cyclone and a vacuum at or adjacent to the third passageway and configured to separate dry material from moist air.

9. The apparatus of claim 3, further comprising a heater positioned to heat material prior to entry into the first chamber through the first conduit.

10. The apparatus of claim 3, further comprising a source of warm dry air injectable into the first conduit with the heated material.

11. The apparatus of claim 1, wherein any of the first housing, second housing, first rotor, and second rotor includes a non-stick coating.

12. The apparatus of claim 11, wherein the non-stick coating is polytetrafluoroethylene, silica, or anodized aluminum.

13. A method comprising:
possessing an apparatus having a first housing defining a cylindrical first chamber;
a second housing defining a cylindrical second chamber;
a shaft that extends through the first and second chambers; and
a first rotor plate within the first chamber, said first rotor plate having a plurality of vanes and being mounted to the shaft for rotation therewith;
a second rotor plate within the second chamber, said second rotor plate having a plurality of vanes and being mounted to the shaft for rotation therewith;
selecting wedge members from an inventory of wedge members, said inventory of wedge members including wedge members having different sizes or shapes;
attaching the selected wedge members to the apparatus such that the selected wedge members are within the first chamber or the second chamber;
selecting tip members from an inventory of tip members, said inventory of tip members including tip members having different sizes or shapes;
attaching the selected tip members to the vanes; and
causing the shaft to rotate, thereby causing the first and second rotor plates to rotate such that zones of varying pressure, pressure differentials, shock waves, expansion fans, or other types of interference waves are formed by the rotation of the vane tips past the wedge members.

14. The method of claim 13, wherein the apparatus includes a first heat exchanger that defines a first heat exchange fluid passageway in conductive heat transfer relationship with the first chamber, and a second heat exchanger that defines a second heat exchange fluid passageway in conductive heat transfer relationship with the second chamber;
wherein the method further includes heating or cooling the first chamber by causing a first fluid to flow through the first heat exchange fluid passageway; and
heating or cooling the second chamber by causing a second fluid to flow through the second heat exchange fluid passageway.

15. The method of claim 14, wherein the flow rate, temperature, or composition of the first fluid is different from the flow rate, temperature, or composition of the second fluid.

16. The method of claim 15, wherein the apparatus includes a first conduit that extends through the first housing and defines a first passageway into the first chamber, a second conduit coaxially disposed with the shaft and defining a second passageway from the first chamber to the second chamber, a third conduit defining a third passageway that is an outlet from the second chamber fourth conduit, and a fourth conduit that defines an fourth passageway extending into the second chamber; and
wherein the method further comprises injecting gas without oxygen into either the first conduit or the fourth conduit.

17. The method of claim 16, further comprising moving the third conduit relative to the shaft to vary the distance between the shaft and the third passageway.

18. The method of claim 16, wherein the apparatus includes a fifth conduit defining a fifth passageway from the first chamber to the exterior of the apparatus; and
wherein the method further comprises removing material from the first chamber via the fifth passageway.
